(19) United States
(12) Patent Application Publication
(10) Pub. No.: US 2009/0070216 A1
(43) Pub. Date: Mar. 12, 2009

(54) Advertising system and method

(76) Inventors: M. Marketta Silvera, Orinda, CA (US); Randolph M. Haldeman, Menlo Park, CA (US); Donald R. Steul, San Francisco, CA (US); Terrance A. Shough, Austin, TX (US)

Correspondence Address: STEVENS LAW GROUP, 1754 TECHNOLOGY DRIVE, SUITE 226, SAN JOSE, CA, 95110, US

(21) Appl. No.: 12/154,965

(22) Filed: May 27, 2008

Related U.S. Application Data
(60) Provisional application No. 60/931,772, filed on May 25, 2007.

(51) Int. Cl. G06Q 30/00; G06Q 40/00; G06Q 90/00

(52) U.S. Cl. 705/14; 705/37

(57) ABSTRACT

Initially, information is received that is related to an online auction that has ended. The received information includes identities of non-winning auction participants and the auctioned product or service. A specific advertisement is then selected from among multiple advertisements associated the auctioned product or service. Certain non-winning auction participants are identified to receive the specific advertisement.

### RELATED APPLICATIONS

This application claims the benefit of U.S. Provisional Application No. 60/931,772, filed May 25, 2007, the disclosure of which is incorporated by reference herein.

### TECHNICAL FIELD

The present invention relates to providing advertisements to non-winning participants in auctions, contests, and other events or activities.

### BACKGROUND

The growth of the Internet has created several new services that provide online auctions for products and services. These online auctions are similar to traditional “in person” auctions, but auction participants are able to bid online from the comfort of their home or office. One such online auction service is operated by eBay® Inc. of San Jose, Calif. Each online auction has an associated product or service for which auction participants place bids. The online auction typically has a prescribed time period during which bids are accepted. At the end of the prescribed time period, the participant who placed the highest bid wins the product or service. Thus, a single participant wins the auction regardless of the number of participants that placed bids during the prescribed time period. The non-winning participants/bidders may attempt to acquire the product or service by placing a bid on a similar product or service in another auction or they may attempt to acquire the product or service through another channel.

In a similar environment, contest participants place an entry in the contest for an opportunity to win a prize, such as a product or service. A particular contest may have one or more winners and may offer a variety of different “prizes”, such as a grand prize, a 2nd place prize, etc. In most contests, there are one or more non-winning contest participants (i.e., contest participants that do not win a prize). These non-winning contest participants may enter a similar contest to win a similar prize or may attempt to acquire the desired prize through another channel.

### BRIEF DESCRIPTION OF THE DRAWINGS

Similar reference numbers are used throughout the figures to reference like components and/or features.

FIG. 1 is a block diagram illustrating an example environment for managing auction and contest data, and generating outbound communications to auction and contest participants.

FIG. 2 is a block diagram illustrating various components of an example data management module.

FIG. 3 is a flow diagram illustrating an embodiment of a procedure for processing auction data and generating one or more outbound communications to non-winning auction participants.

FIG. 4 is a flow diagram illustrating an embodiment of a procedure for processing contest data and generating one or more communications for non-winning contest participants.

FIG. 5 is a block diagram illustrating an example computing device.

### DETAILED DESCRIPTION

The systems and methods described herein provide a mechanism for communicating advertisements and other offers to non-winning participants of auctions, contests, and similar events or activities. By participating in an auction, contest or similar event/activity, the participant has expressed an interest in the product or service associated with the auction, contest or event/activity. This information is useful to advertisers and other businesses. For example, knowledge that an auction participant is interested in a particular product or service is useful in generating targeted advertisements for that auction participant.

Although particular examples discussed herein refer to auctions and contests, similar systems and methods can be utilized to generate and communicate advertisements associated with any event or activity. A contest is any event or activity that allows participants to “enter” the contest with a possibility of winning a prize, such as a product or service. A participant can enter a contest online, by telephone, by mail, by email, using a text message, or any other entry format. A contest may also be referred to as a “sweepstakes”, “lottery”, “competition”, “game”, “challenge”, and the like. The examples discussed herein refer to specific types of advertisements that are sent to one or more participants. Any type of advertisement can be communicated to participants via any communication media and communication mechanism, such as audio messages, text messages, instant messages, email messages, fax messages, printed messages, video messages, and so forth.

A specific type of advertisement, referred to as a “targeted advertisement”, is communicated to a specific participant (or group of participants) based on information known about that participant (or group). This information about the participant may include information related to contests or auctions the participant has entered. For example, if a participant is an avid bicycle racer, targeted advertisements would include advertisements related to upcoming bicycle races, bicycle racing apparel, and bicycle racing magazines. The more information an advertiser has about a participant, the more effectively advertisements can be targeted to that participant.

Targeted advertisements are beneficial to the advertiser because they generally receive a better response rate than non-targeted advertisements. For example, sending bicycle racing advertisements to someone who has no interest in bicycles is not likely to generate a positive response. Further, such advertisements may be annoying to participants that have no interest in the content of the advertisement. Targeted advertisements are less likely to be an annoyance to participants because there is a strong likelihood that the participant has an interest in the content of the advertisement. Thus, increased knowledge about the participant can benefit the advertiser with improved response rate and benefit the participant by reducing the number of non-interesting advertisements received.

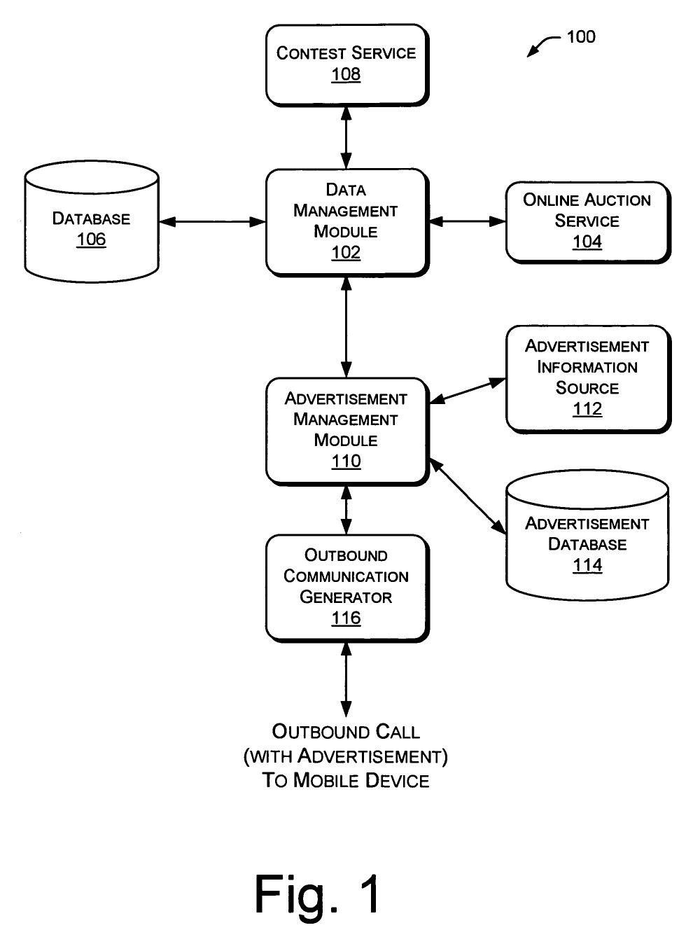

FIG. 1 is a block diagram illustrating an example environment 100 for managing auction and contest data, and generating outbound communications to auction and contest participants. A data management module 102 is coupled to an online auction service 104, a contest service 108, and a database 106. Data management module 102 receives and stores various data, such as auction-related data and contest-related data. For example, data management module 102 receives auction data from one or more online auction services 104, such as eBay, and receives contest data from one or more contest services 108. Auction-related data includes information about pending and completed auctions, such as the product or service being auctioned, winning bidder, winning bid amount, non-winning bidders, and the highest bids associated with each of the non-winning bidders. Contest-related data includes information about pending and completed contests, such as the sponsor of the contest, the prizes offered during the contest, and the individuals or groups to which the contest was directed.

Data management module 102 is also coupled to an advertisement management module 110, which handles the selection and generation of advertisements for communication to non-winning auction and/or contest participants. Advertisement management module 110 is coupled to advertisement information source 112 and advertisement database 114. Advertisement information source 112 provides various advertisement-related information to advertisement information source 112. This advertisement-related information includes advertisement content, products or services associated with particular advertisement content, target users for each advertisement, when the advertisement should be communicated to users, geographic areas in which the advertisement can be communicated, and the like. Advertisement management module 110 stores the advertisement-related information in advertisement database 114.

For example, Circuit City (an advertisement information source) provides an advertisement to the advertisement management module 110 along with advertisement-related information. The advertisement-related information identifies the exact language of the advertisement, product/service name, target users (e.g., the five highest non-winning bidders or all non-winning contest participants), the price to offer the target users, when the advertisement should be communicated to the users (e.g., two minutes after the auction ends or one week after the contest results are announced), and where the advertisement should be communicated (e.g., communicated to users in California, Oregon, and Washington).

Upon completion of a particular online auction or contest, advertisement management module 110 creates one or more advertisements for the non-winning auction or contest participants based on the received advertisement-related information. In one embodiment, advertisement management module 110 searches advertisement database 114 after each auction or contest is completed to identify appropriate advertisement(s) to communicate to non-winning participants. Advertisement management module 110 then receives participant information (e.g., participant name, email address and telephone number) associated with the particular auction or contest for which the advertisement is being communicated. This participant information is received from data management module 102.

After creating one or more advertisements, advertisement management module 110 provides the advertisements to an outbound communication generator 116, which communicates the advertisements to the intended recipients. For example, outbound communication generator 116 may generate phone calls to a telephone (e.g., cellular phone, conventional phone, and the like), text messages to a telephone or other device, email messages to one or more email addresses, etc. In the case of a phone call, outbound communication generator 116 begins playing the advertisement when a user answers the phone. Outbound communication generator 116 is also capable of receiving responses to the outbound communication, such as voice responses from a telephone, text responses from a cellular phone, email responses, etc.

The advertisement information source 112 is typically charged a fee for each outbound communication generated by outbound communication generator 116. Additionally, the advertisement information source 112 may be charged an additional fee if the recipient of the communication accepts the offer in the advertisement.

In a specific implementation, participants choose to receive various advertisements by “opting in” to the advertisement service. If a specific participant does not want to receive advertisements related to auction or contest items, that participant simply chooses not to opt-in to the advertisement service.

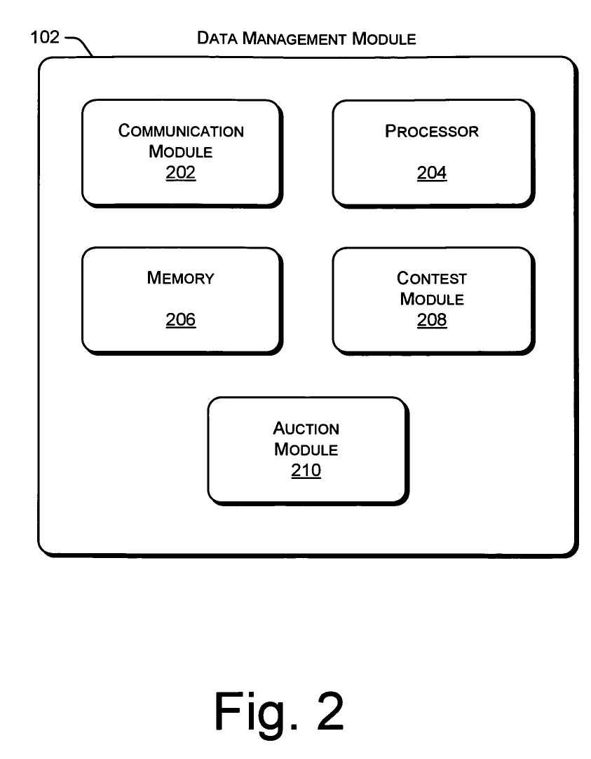

FIG. 2 is a block diagram illustrating various components of example data management module 102. Data management module 102 includes a communication module 202, a processor 204, and a memory 206. Communication module 202 allows data management module 102 to communicate with other devices, such as databases, networks, other computer systems, and so on. Processor 204 executes various instructions to implement the functionality provided by data management module 102. Memory 206 stores these instructions as well as other data used by processor 204 and other modules contained in data management module 102.

Data management module 102 also includes a contest module 208 and an auction module 210. Contest module 208 manages information associated with one or more contests, such as contest participants, contest prizes, contest dates, and the like. Auction module 210 manages information associated with one or more auctions, such as auction bidders, auction items, auction dates, highest bids, non-winning bids, and the like.

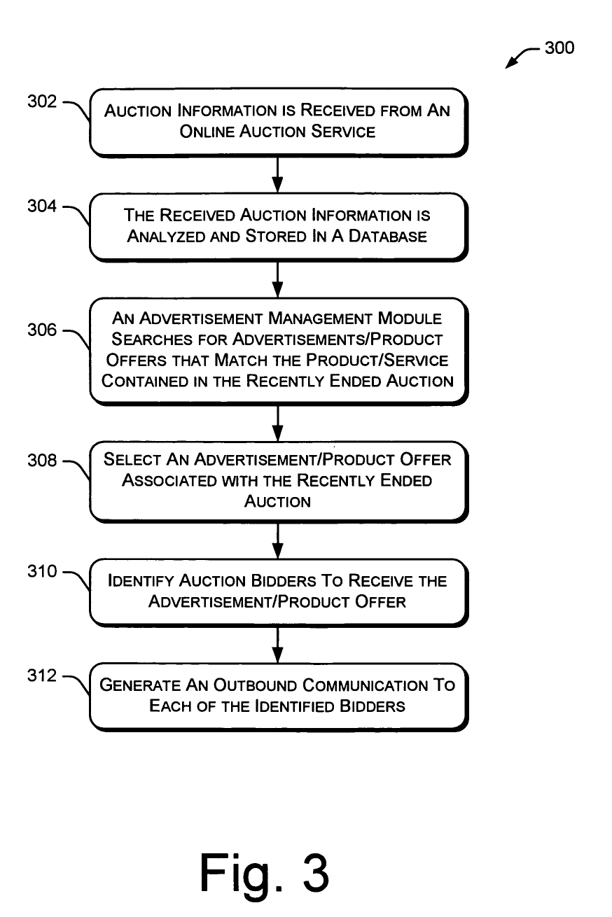

FIG. 3 is a flow diagram illustrating an embodiment of a procedure 300 for processing auction data and generating one or more outbound advertisements (or other communications) to non-winning auction participants. In one embodiment, procedure 300 is implemented in the environment shown in FIG. 1. In other embodiments, procedure 300 is implemented using one or more computing devices or other systems capable of performing the operations shown in FIG. 3.

Initially, auction information is received from an online auction service (block 302). This information may include names of non-winning auction participants, the product or service that was the subject of the auction, the winning bid, the highest non-winning bids, the auction ending date, and related information. The received auction information is analyzed and stored in a database (block 304). Analysis of the received auction information may include identifying other auctions in which the non-winning auction participants have previously placed bids.

Procedure 300 continues as an advertisement management module searches for advertisements and/or product offers that match the product or service contained in the recently ended auction (block 306). Additionally, the advertisement management module may consider other information in searching for advertisements. This other information includes, for example, the geographic area in which the participant lives (and the demographics associated with that geographic area), past purchases by the participant (in an auction or through other channels), and past requests for information by the participant (such as calls for information about digital cameras or other photographic equipment).

The advertisement management module then selects a specific advertisement and/or product offer associated with the recently ended auction (block 308). The advertisement management module can select a specific advertisement using a variety of techniques, such as round-robin (rotating among all of the relevant advertisements), highest bidder, or most relevant advertisement. Using the highest bidder technique, each advertiser associates a maximum bid price with each advertisement. When selecting among multiple advertisements, the one with the highest bid is selected. Using the most relevant advertisement technique, each of the relevant advertisements is rated based on how closely it matches the information known about the auction and/or the participant. The advertisement with the strongest match is selected.

The procedure continues by identifying one or more auction bidders to receive the selected advertisement (block 310). For example, a particular advertisement may be provided to all non-winning auction bidders or limited to non-winning bidders that placed a bid above a certain amount. The criteria for identifying bidders to receive the selected advertisement may be set by the source of the advertisement or by another individual or entity. Procedure 300 then generates an outbound communication to each of the identified bidders (block 312). In a particular embodiment, the outbound message is an audio message sent to a bidder's telephone, cellular phone, or other communication device. In other embodiments, the outbound message can be any type of message sent via any communication mechanism, such as an email message, a text message, fax message, and the like. In specific implementations, an outbound message is sent using multiple formats, such as sending the same information in an audio message and an email message simultaneously.

For example, non-winning auction participants may receive a telephone call that communicates an advertisement related to the auction in which they recently participated. If that auction was for a Nikon 120D camera, the advertisement may offer the same camera (or a similar camera from a competitor) at a local store or via an online store. The advertisement may offer the camera at the same price as the winning bid or at a different (higher or lower) price. The merchant associated with the advertisement typically determines the price offered in the advertisement. Additionally, the advertisement may offer additional “features” or “services” not offered in the auction, such as additional free camera accessories (free carrying case or free photo album) or a free (or discounted) extended service plan. The following is an example advertisement:
Hello Mr. Jones, you opted in to receive the following message concerning the eBay auction for the Nikon 120D camera that just ended. We're sorry you did not win the auction, but good news, your local Camera City store has the Nikon 120D camera in stock and will match the winning bid price. Also, Camera City will give you a free one year extended service plan on your new camera. Would you like to take advantage of this offer from Camera City?
   If the auction participant accepts the offer, the auction participant is provided with directions to the local Camera City store and, optionally, an order identification number that allows the auction participant to quickly purchase the camera which will be waiting at the customer service desk of the Camera City store.

An advertisement may be communicated to any number of non-winning auction participants, such as the five highest non-winning bidders, all non-winning bidders, or the highest non-winning bidder. Additionally, the advertisement may be communicated to auction users that did not bid on the auction, but had identified the auction as one being “watched” or “monitored”. Although these users did not actually bid on the product or service, they expressed an interest in the product or service associated with the auction. Further, the advertisement may be communicated to users that bid on the same product or service in an earlier auction (e.g., bids placed in earlier auctions within the past five days).

Different advertisements may be communicated to different non-winning auction participants. For example, the five highest non-winning bidders for the Nikon 120D camera receive the Camera City advertisement discussed above. The remaining non-winning bidders receive an advertisement indicating that Camera City sells Nikon cameras and other brands at great prices. Users who were “watching” or “monitoring” the auction receive an advertisement for Nikon cameras, but the advertisement does not mention any particular store or pricing information. Any number of different advertisements may be communicated to different non-winning auction participants or groups of non-winning participants.

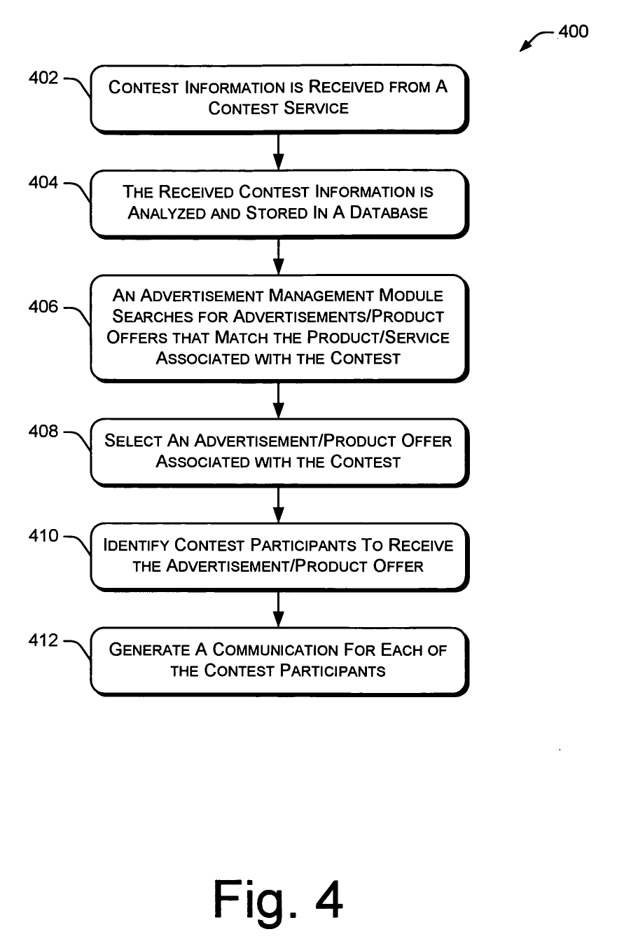

FIG. 4 is a flow diagram illustrating an embodiment of a procedure 400 for processing contest data and generating one or more outbound advertisements (or other communications) to non-winning contest participants. Procedure 400 is similar to procedure 300 discussed above with respect to FIG. 3, but focused on contest participants instead of auction participants. In one embodiment, procedure 400 is implemented in the environment shown in FIG. 1. In other embodiments, procedure 400 is implemented using one or more computing devices or other systems capable of performing the operations shown in FIG. 4.

Initially, contest information is received from a contest service (block 402). This information may include names of non-winning contest participants, the product or service that was the prize in the contest, the number of contest entries, the contest ending date, and related information. The received contest information is analyzed and stored in a database (block 404). Analysis of the received contest information may include identifying other contests that the participant previously entered.

Procedure 400 continues as an advertisement management module searches for advertisements and/or product offers that match the product or service contained in the contest (block 406). Additionally, the advertisement management module may consider other information in searching for advertisements. This other information includes, for example, the geographic area in which the participant lives (and the demographics associated with that geographic area), past purchases by the participant (through any channel), and past requests for information by the participant (such as calls for information about a particular product or service).

The advertisement management module then selects a specific advertisement and/or product offer associated with the contest (block 408). The advertisement management module can select a specific advertisement using a variety of techniques, such as round-robin, highest bidder, or most relevant advertisement. These example techniques are discussed above with respect to FIG. 3.

The procedure continues by identifying one or more contest participants to receive the selected advertisement (block 410). For example, a particular advertisement may be provided to all contest participants or limited to non-winning contest participants. The criteria for identifying participants to receive the selected advertisement may be set by the source of the advertisement or by another individual or entity. Procedure 400 then generates an outbound communication to each of the identified contest participants (block 412). In a particular embodiment, the outbound message is an audio message sent to a participant's telephone, cellular phone, or other communication device. In other embodiments, the outbound message can be any type of message sent via any communication mechanism, such as an email message, a text message, fax message, and the like. In specific implementations, an outbound message is sent using multiple formats, such as sending the same information in an audio message and an email message simultaneously. The outbound message may be sent to participants as soon as they enter the contest, after the contest has ended, or at any other prescribed time or event.

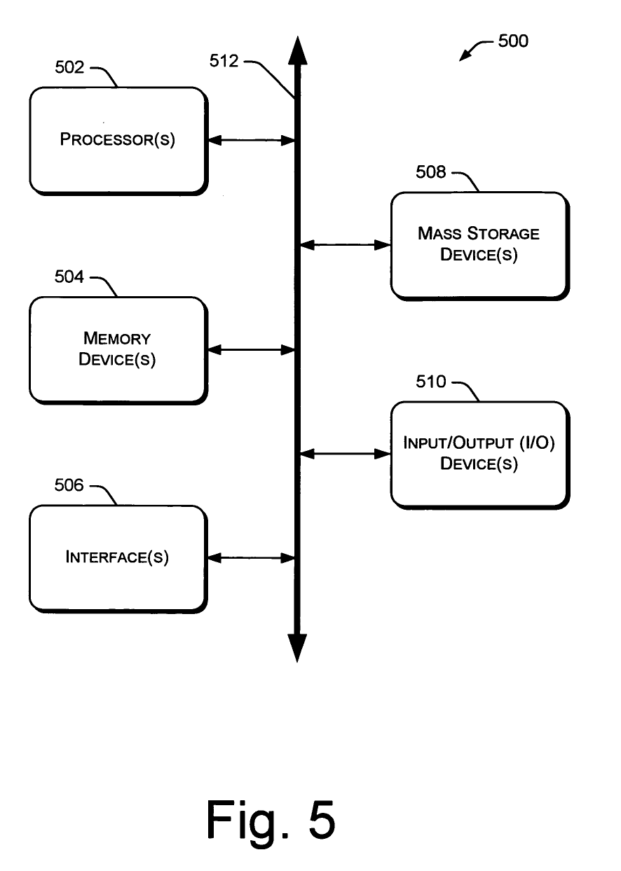

FIG. 5 is a block diagram illustrating an example computing device 500. Computing device 500 may be used to perform various procedures, such as those discussed herein. Computing device 500 can function as a server, a client, or any other computing entity. Computing device 500 can be any of a wide variety of computing devices, such as a desktop computer, a notebook computer, a server computer, a handheld computer, and the like.

Computing device 500 includes one or more processor(s) 502, one or more memory device(s) 504, one or more interface(s) 506, one or more mass storage device(s) 508, and one or more Input/Output (I/O) device(s) 510, all of which are coupled to a bus 512. Processor(s) 502 include one or more processors or controllers that execute instructions stored in memory device(s) 504 and/or mass storage device(s) 508. Processor(s) 502 may also include various types of computer-readable media, such as cache memory.

Memory device(s) 504 include various computer-readable media, such as volatile memory (e.g., random access memory (RAM)) and/or nonvolatile memory (e.g., read-only memory (ROM)). Memory device(s) 504 may also include rewritable ROM, such as Flash memory.

Mass storage device(s) 508 include various computer readable media, such as magnetic tapes, magnetic disks, optical disks, solid state memory (e.g., Flash memory), and so forth. Various drives may also be included in mass storage device(s) 508 to enable reading from and/or writing to the various computer readable media. Mass storage device(s) 508 include removable media and/or non-removable media.

I/O device(s) 510 include various devices that allow data and/or other information to be input to or retrieved from computing device 500. Example I/O device(s) 510 include cursor control devices, keyboards, keypads, microphones, monitors or other display devices, speakers, printers, network interface cards, modems, lenses, CCDs or other image capture devices, and the like.

Interface(s) 506 include various interfaces that allow computing device 500 to interact with other systems, devices, or computing environments. Example interface(s) 506 include any number of different network interfaces, such as interfaces to local area networks (LANs), wide area networks (WANs), wireless networks, and the Internet.

Bus 512 allows processor(s) 502, memory device(s) 504, interface(s) 506, mass storage device(s) 508, and I/O device(s) 510 to communicate with one another, as well as other devices or components coupled to bus 512. Bus 512 represents one or more of several types of bus structures, such as a system bus, PCI bus, IEEE 1394 bus, USB bus, and so forth.

For purposes of illustration, programs and other executable program components are shown herein as discrete blocks, although it is understood that such programs and components may reside at various times in different storage components of computing device 500, and are executed by processor(s) 502. Alternatively, the systems and procedures described herein can be implemented in hardware, or a combination of hardware, software, and/or firmware. For example, one or more application specific integrated circuits (ASICs) can be programmed to carry out one or more of the systems and procedures described herein.

Although the description above uses language that is specific to structural features and/or methodological acts, it is to be understood that the invention defined in the appended claims is not limited to the specific features or acts described. Rather, the specific features and acts are disclosed as exemplary forms of implementing the invention.

1. A method comprising:
receiving information associated with an online auction that has ended, wherein the received information includes identities of non-winning auction participants and an auctioned product or service;
identifying a plurality of advertisements associated with the auctioned product or service;
selecting a specific advertisement from the plurality of identified advertisements; and
identifying non-winning auction participants to receive the specific advertisement.

2. A method as recited in claim 1 further comprising communicating the specific advertisement to the identified non-winning auction participants.

3. A method as recited in claim 1 wherein the received information further includes the highest non-winning bid.

4. A method as recited in claim 1 wherein the received information further includes identities of users that monitored the online auction but did not place a bid on the online auction.

5. A method as recited in claim 1 wherein the received information further includes a product category associated with the online auction.

6. A method as recited in claim 1 further comprising storing the received information in a database.

7. A method as recited in claim 1 wherein the specific advertisement is associated with an entity that sells the same auctioned product or service.

8. A method as recited in claim 1 wherein the specific advertisement includes a special offer from an entity that sells the same auctioned product or service.

9. A method as recited in claim 1 wherein the specific advertisement is associated with the manufacturer of the auctioned product or service.

10. A method comprising:
receiving information associated with a contest, wherein the received information includes identities of contest participants and prizes offered to contest winners;
identifying a plurality of advertisements associated with the prizes offered to contest winners;
selecting a specific advertisement from the plurality of identified advertisements; and
identifying contest participants to receive the specific advertisement after the contest has ended.

11. A method as recited in claim 10 wherein the specific advertisement is associated with an entity that sells at least one of the prizes offered to contest winners.

12. A method as recited in claim 10 wherein the specific advertisement includes a special offer from an entity that sells at least one of the prizes offered to contest winners.

13. A method as recited in claim 10 wherein the specific advertisement is created by an entity that sells at least one of the prizes offered to contest winners.

14. A method as recited in claim 10 further comprising communicating the specific advertisement to the identified contest participants.
